(19) United States
(12) Patent Application Publication
(10) Pub. No.: US 2020/0325853 A1
(43) Pub. Date: Oct. 15, 2020

(54) DIAPHRAGM CARBURETOR

(71) Applicant: ZAMA JAPAN CO. LTD., Iwate (JP)

(72) Inventors: Daisuke Suzuki, Iwate (JP); Toshiyuki Kuyo, Iwate (JP); Issei Fumoto, Iwate (JP)

(21) Appl. No.: 16/722,739

(22) Filed: Dec. 20, 2019

(30) Foreign Application Priority Data
Dec. 11, 2018 (JP) 2018-231871

(51) Int. Cl. F02M 17/04; F02M 19/06; F02M 9/02; F02M 1/02

(52) U.S. Cl. CPC F02M 17/04; F02M 1/02; F02M 9/02; F02M 19/06

(57) ABSTRACT

Disclosed are example embodiments of a diaphragm carburetor. Example embodiments includes: a pressure regulator; a fuel chamber for storing fuel to be introduced into an intake channel; a diaphragm; an atmospheric-pressure chamber partitioned by the diaphragm 100; a fuel supply channel that feeds the fuel, a return channel that is connected to the fuel supply channel and returns excess fuel that is not introduced into the fuel chamber to a fuel-tank side. The fuel is supplied into the intake channel while being adjusted to a predetermined pressure by the pressure regulator. The diaphragm carburetor also includes an opening and closing mechanism that opens at engine startup to allow the fuel to pass through and closes during normal driving to prevent the fuel from passing through.

### CROSS-REFERENCED TO RELATED APPLICATION

The subject application claims the benefit of Japanese Patent Application No. 2018-231871, filed Dec. 11, 2018, which application is incorporated herein by reference in its entirety.

### TECHNICAL FIELD

The present disclosure relates to a carburetor, specifically and not by way of limitation, some embodiments are related to a diaphragm carburetor that can be used in a portable work machine such as a chainsaw or a brush cutter.

### BACKGROUND

A small general-purpose engine used in a portable work machine such as a chainsaw or a brush cutter is often held in a tilted position during the course of normal usage. As such, when a float carburetor is used in a portable work machine, the flow of fuel to the engine is more likely to become unstable due to it being regularly tilted. To prevent this, portable work machines often use a diaphragm carburetor in place of a floating carburetor. Diaphragm carburetors are more likely to supply fuel in a stable manner without being affected by tilting.

Conventional diaphragm carburetors use a pump to introduce fuel into an intake channel while regulating the fuel pressure of the fuel using a pressure regulator. This allows the diaphragm carburetor to operate independently of gravity and enables it to stably supply fuel in any position (even tiled). Some conventional diaphragm carburetors also have a return channel that is continuously open to the fuel-tank side to return fuel. This can help with the startup of the engine. However, with this design, it is often the case that too much fuel is returned to the fuel tank during the operation of the engine.

One way to solve this problem is to use an electronically control fuel injection system that can precisely control the amount of fuel being supplied. However, this solution is not cost-effective for engines in portable work machines, where the demand is for a simple configuration and low costs.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a schematic diagram of a diaphragm carburetor in accordance with some embodiments of the present disclosure.

FIGS. 2A, 2B, and 2C are partial longitudinal section views illustrating an example of an opening and closing (valve) mechanism in the diaphragm carburetor of FIG. 1 in accordance with some embodiments of the present disclosure.

FIG. 2A is a cross-sectional view of the valve mechanism at a plane in an axial direction in an open state in accordance with some embodiments of the present disclosure.

FIG. 2B is a cross-sectional view of the valve mechanism at a plane perpendicular to the axial direction in the open state in accordance with some embodiments of the present disclosure.

FIG. 2C is a cross-sectional view of the valve mechanism at a plane perpendicular to the axial direction in the close state in accordance with some embodiments of the present disclosure.

FIGS. 3A and 3B are partial longitudinal section views sectioned at a plane in an axial direction of a valve mechanism in accordance with some embodiments of the present disclosure.

FIG. 3A is an example where a piston member is provided with two O rings in accordance with some embodiments of the present disclosure.

FIG. 3B is an application example of FIG. 2A.

FIGS. 4A and 4B are partial longitudinal section views of another valve mechanism sectioned at a plane in the axial direction in accordance with some embodiments of the present disclosure.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

Disclosed herein is a new and innovative diaphragm carburetor that exhibits favorable engine startup performance and stability during normal driving. The disclosed diaphragm carburetor includes a pressure regulator, a fuel chamber, an intake channel, a fuel supply channel, an atmospheric-pressure chamber, and a diaphragm. Fuel can be stored in the fuel chamber, which can be introduced into an intake channel. The atmospheric-pressure chamber and the intake channel are partitioned by the diaphragm. A pump can pump fuel from a fuel supply tank into the fuel chamber via a fuel supply channel.

The diaphragm carburetor can also include a return channel that is connected to the fuel supply channel. The return channel can return excess fuel that did not make it into the fuel chamber back to the fuel supply tank. The pressure regulator is configured to regulate the pressure of the intake channel and/or the fuel chamber to a predetermined pressure. The return channel includes an opening-and-closing (e.g., valve) mechanism that is designed to open at engine startup to allow the fuel to pass through and close during normal operation (e.g., while the engine is running) to prevent the fuel from passing through. In this manner, the valve mechanism can open at engine startup to reflux any excess fuel to the fuel supply tank. Additionally, during normal operation, the valve mechanism enables stable engine performance by preventing any fuel from flowing out to the fuel supply tank. In some embodiments, the valve mechanism can allow some fuel to flow to the fuel supply tank during normal operation. In other words, the valve mechanism can be configured to allow some fuel flow but prevent excessive fuel flow.

The valve mechanism in the return channel can have a valve body that is designed to open in conjunction with a choke operation at engine startup and close when the engine is not in a choke operation. The valve body of the valve mechanism is configured to actuate in conjunction with the choke operation of the engine. In other words, the valve body can automatically actuate in conjunction with the choke operation. In this manner, there is no need to actuate the valve mechanism to open or close the valve body independently of the choke operation.

When the valve mechanism is in an open position, the return channel is communicated to a fuel-supply-channel side (e.g., the fuel supply tank). For instance, the pathway between the return channel and the fuel-supply-channel side is open to allow free fluid flow. The return channel includes an opening (portion) that is disposed on an inner peripheral face of an insertion hole so that a choke shaft to rotate axially within a predetermined rotational range. The opening portion can be proximally positioned to the fuel-tank side. In some embodiments, the opening portion can be distally positioned to the fuel-tank side. Alternatively, the opening portion can be centrally located.

The choke shaft includes a notch on the outer peripheral face of the shaft. The notch can be formed to have a predetermined circumferential length or angle. For example, the notch can cover 45 degrees or a quarter of the circumference. The notch can also be formed to have a predetermined depth (from a point on the outer surface toward an axial point). In this way, the chock shaft has a notch of a certain depth. In some embodiments, the notch is disposed such that it can be rotationally operated between a closed position and an open position. During a choke release (non-choking position), the notch is rotated away (not present) from the fuel supply channel and the return channel. In this position, the choke shaft simultaneously blocks both channels.

When the engine is in the choke position, the choke shaft is configured to rotate such that the notch is on the same side of both opening portions (i.e., return and fuel supply channels). This creates an open pathway connecting between the fuel supply channel, the notch, and the return channel. One of the advantages of this new and innovative design is that it requires minimum changes to the engine configuration.

In some embodiments, the valve mechanism can be a piston member that performs a piston operation in an axial direction. In one position, the piston member exposes both fuel supply channel (in channel) and return channel (out channel), and thereby creating an open passage therebetween.

The piston can be disposed within a cylinder hole, which can have a return channel on the inner-side surface of the hole. The supply channel can be disposed on a distal-end side of the hole, which is a surface that is perpendicular to the inner-side surface of the hole. When the piston member is actuated, the hole on the distal-end side can be exposed while the hole on the inner-side face of the cylinder hole can be blocked until the piston is actuated to a certain position. When the piston is in a fully distal position (farthest away from the proximal-end side of the hole), both the fuel supply hole and return hole and fluidically communicated via a chamber created by the piston being in the distal position. In some embodiments, spring members are disposed within the cylinder hole of the piston such that the spring members apply a constant pressure on the piston in the opposite direction of the distal-end side of the hole, which is the proximal end of the piston. The piston member and the spring members can perform a sliding operation between a closed and an open position. In the closed position, which is at choke release, the piston member simultaneously closes both opening portions (channels) by being positioned on a deep side (distal end) of the cylinder hole by having the distal-end side pressed by the portion of the choke lever. In the open position, during choking, piston member simultaneously opens both opening portions and causes these to be communicated to each other by protruding the piston member from the cylinder hole.

The disclosed diaphragm carburetor can use a pump to actuate a pump diaphragm, which can be disposed on the upstream side of the pressure regulator. In some embodiments, the pressure regulator can be in the fuel supply channel.

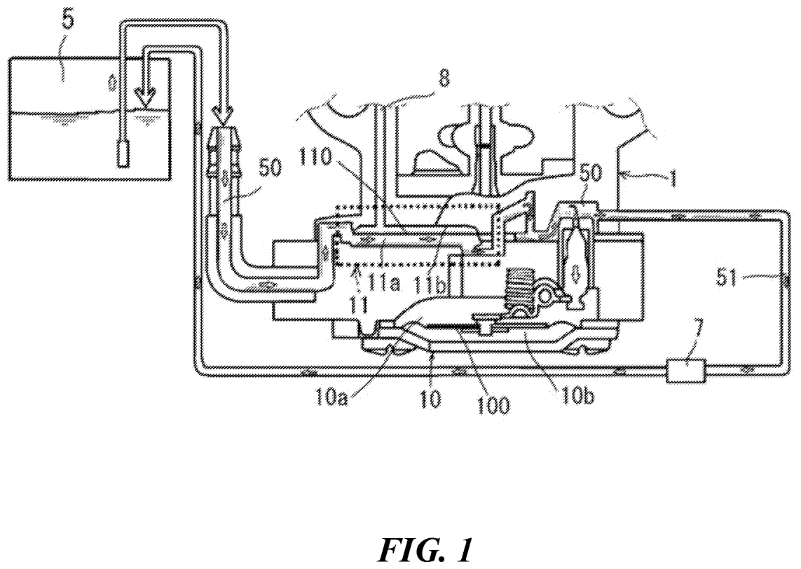

FIG. 1 is a schematic illustrating an engine with a diaphragm carburetor 1 in accordance with some embodiments of the present disclosure. Diaphragm carburetor 1 includes a pressure regulator 10, a fuel chamber 10a, an atmospheric-pressure chamber 10b, and a diaphragm 100. Fuel chamber 10a can store fuel to be introduced into an intake channel (not shown). The fuel chamber 10a and atmospheric-pressure chamber 10b are partitioned by the diaphragm 100.

Diaphragm carburetor 1 includes a fuel supply channel 50 that is connected to a fuel-tank 5. A pump can be used to pump fuel to fuel chamber 10a. Diaphragm carburetor 1 also includes return channel 51 that is connected to fuel supply channel 50. Return channels allows excess fuel that did not make it into fuel chamber 10a to be returned to fuel-tank 5. This configuration enables fuel to be supplied to the intake channel while adjusting the fuel to a predetermined pressure using pressure regulator 10. In this way, a stable fuel supply is provided even when the engine is being held in various positions—including tilted positions.

Furthermore, in diaphragm carburetor 1 of the present embodiment, a pump unit 11 that introduces and pumps the fuel from the fuel-tank 5 side is provided as the pump means on an upstream side immediately before the pressure regulator 10 in the fuel supply channel 50. The pump unit 11 is configured to actively send out the fuel introduced into the pump chamber 11a toward the pressure regulator 10 by reciprocatingly displacing a diaphragm (pump diaphragm) 110 while introducing pulsation from the engine into a pulse pressure chamber 11b via a pulse pressure introduction channel 8.

Furthermore, opening and closing mechanism 7 can open at engine startup to allow the fuel to pass through and can close during normal driving to prevent the fuel from passing through. Closing mechanism 7 is disposed approximately midway down the return channel 51, which returns the excess fuel to a fuel tank 5. This is configuration improves a startup performance of the engine by refluxing the excess fuel to the fuel tank at engine startup. Moreover, this enables stable engine performance by preventing the fuel from excessively flowing out to the fuel-tank 5 side during normal driving.

In some embodiments, opening and closing mechanism 7 is provided with a valve body that opens in conjunction with a choke operation at engine startup and closes upon a choke state being released. This enables the opening and closing mechanism 7 to be actuated in conjunction with a normal choke operation alone, without the need for a separate operation to actuate the opening and closing mechanism.

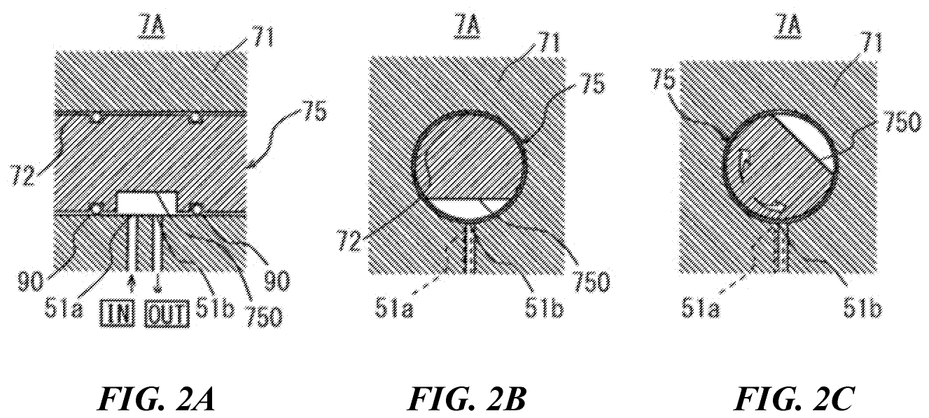

Various methods for actuating the opening and closing mechanism 7 in conjunction with the choke operation is described in detail below with reference to FIGS. 2 to 4.

FIGS. 2A-2C are different views illustrating opening and closing mechanism 7A that can be actuated by rotationally operating a choke shaft 75 in accordance with some embodiments of the present disclosure. FIG. 2A is a cross-sectional view longitudinally sectioned at a plane in an axial direction in a situation where the valve body is in an open state. FIG. 2B is a cross-sectional view longitudinally sectioned at a plane perpendicular to the axial direction in the situation where the valve body is in the open state. FIG. 2C illustrates a situation where the valve body is changed from the state of FIG. 2B to a closed state.

Referring to FIG. 2A, an opening portion 51a is communicated to the return channel 51 of a fuel-supply-channel 50 side, and an opening portion 51b is communicated to the return channel 51 to the fuel-tank 5 side. Opening portion 51a and 51b are provided in proximal positions on an inner peripheral face of an insertion hole 72 provided in a body 71 so the choke shaft 75 can rotate axially therein within a predetermined range. The inserted choke shaft 75 has a notch 750 formed across a predetermined range in a circumferential direction on an outer peripheral face thereof. This configures the valve body.

Furthermore, as illustrated in FIG. 2B, the choke shaft 75 is disposed in a state of being able to be rotationally operated between an open position during choking that simultaneously opens both opening portions 51a, 51b and causes these to be communicated to each other via a peripheral-face side of notch 750. When the choke shaft 75 is in an intermediate position, it is in a closed position that simultaneously closes both opening portions 51a, 51b via a peripheral-face side whereon the notch 750 is not present. This enables reliable opening and closing operations of the opening and closing mechanism 7A without overly complicating an apparatus configuration.

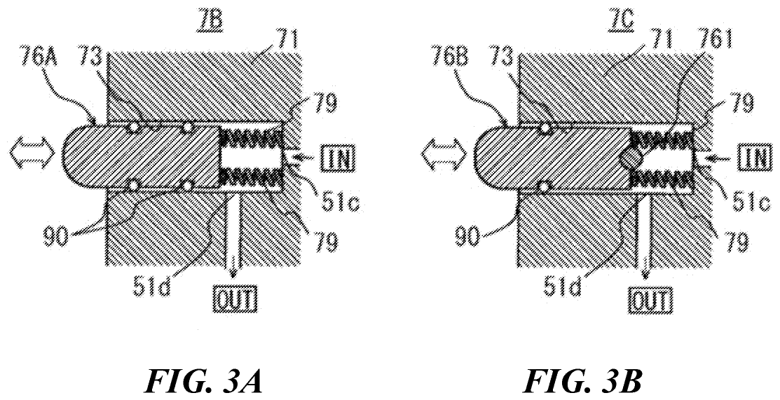

FIG. 3A illustrates an example opening and closing mechanism 7B, which is another example of the opening and closing mechanism 7 of FIG. 1. Closing mechanism 7B is provided with a piston member 76A that performs a piston operation in an axial direction while having a distal-end side formed in a hemispherical shape being abutted by a portion of a choke lever (not shown). Body 71 includes a cylinder hole 73. Piston member 76A is provided such that it can slide back-and-forth in a depth direction while having the distal-end side thereof exposed to the outside. On an inner-side face of this cylinder hole 73, an opening portion 51c is communicated to the return channel 51 to the fuel-supply-channel 50 side, and an opening portion 51d is communicated to the return channel 51 to the fuel-tank 5 side.

Piston member 76A has a proximal-end side being pressed in a distal direction by spring members 79, which are on the proximal side. Piston member 76A performs a sliding operation between a closed position at choke release, where the piston member 76A simultaneously closes both opening portions 51c, 51d by being positioned on a deep side (proximal side) of the cylinder hole 73. By having the distal-end side thereof pressed by a sloped portion or the like of the choke lever being released (not shown) and an open position during choking, the piston member 76A simultaneously opens both opening portions 51c and 51d and causes these to be communicated to each other while protruding from the cylinder hole 73. This enables reliable opening and closing operations of the opening and closing mechanism 7B in conjunction with the choke operation.

FIG. 3B illustrates an opening and closing mechanism 7C as an application example of the opening and closing mechanism 7B of FIG. 3A. Mechanism 7C is similar to mechanism 7B. However, piston member 76A of opening and closing mechanism 7B has two O rings 90; whereas, mechanism 7C has one O-ring 90 on the distal-end side. As shown in FIG. 3B, a valve body 761 protruding in a hemispherical shape is provided on a proximal-end face of piston member 76A. Valve body 761 can be a soft ball 761. The opening portion 51c (from where the fuel flows in) is on the proximal side of body 71. When piston member 76B and ball 761 are driven to the proximal side of body 71, ball 761 can engage opening portion 51c. This enables the fuel inflow from opening 51c to be reliably closed during normal driving.

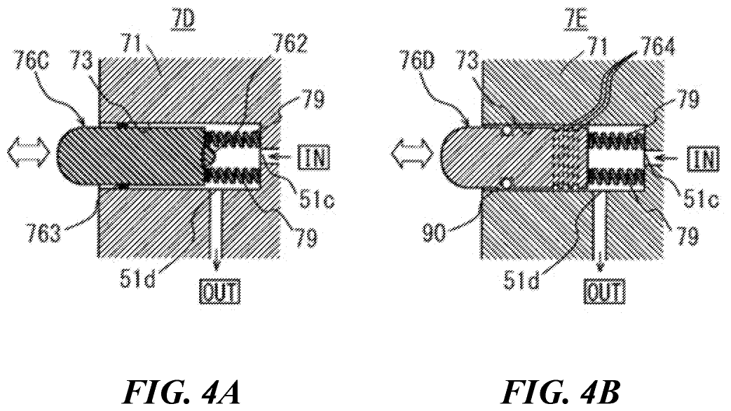

FIG. 4A illustrates an opening and closing mechanism 7D as an application example of the opening and closing mechanism 7C of FIG. 3B. It is made by integrally molding an entirety of a piston member 76C using a soft material such as rubber or plastic. Instead of the O ring 90, an O-ring-shaped convex portion 763 is provided. Additionally, instead of the soft ball 761, a soft convex portion 762 is provided. This enables manufacturing costs to be kept even lower.

FIG. 4B illustrates an opening and closing mechanism 7E as an application example of the opening and closing mechanism 7B of FIG. 3A. A characteristic feature of mechanism 7E is a piston member 76D with three parallel grooves 764 in an outer peripheral face of piston member 76D instead of O-ring. Grooves 764 enable a component-count reduction while exhibiting a pressure retention function equivalent to or greater than that of the piston member 76A, making it easy to ensure engine stability during normal driving.

As described above, the present invention is able to provide a diaphragm carburetor that is of a simple configuration yet has a favorable engine startup performance and favorable performance stability during normal driving.

The figures and the foregoing description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof.

### REFERENCE SIGNS LIST

1 diaphragm carburetor;

5 fuel tank;

7, 7A, 7B, 7C, 7D, 7E opening and closing mechanism;

8 pulse pressure introduction channel;

10 pressure regulator; 10a fuel chamber;

10b atmospheric chamber;

11 pump unit;

11a pump chamber;

11b pulse pressure chamber;

50 fuel supply channel;

51 return channel;

51a, 51b, 51c, 51d opening portion;

71 body;

72 insertion hole;

73 cylinder hole;

75 choke shaft;

76A, 76B, 76C, 76D piston member;

79 spring member;

90 O ring;

100, 110 diaphragm;

750 notch;

761 soft ball;

762 soft convex portion;

763 O-ring-shaped convex portion;

764 groove

1. A diaphragm carburetor, comprising:
a pressure regulator wherein a fuel chamber storing fuel to be introduced into an intake channel and an atmospheric-pressure chamber are partitioned by a diaphragm, the fuel being supplied into the intake channel while being adjusted to a predetermined pressure by the pressure regulator;
a fuel supply channel that feeds the fuel, which is introduced from a fuel-tank side by a pump means, to the fuel chamber; and
a return channel that is connected to the fuel supply channel and returns excess fuel that is not introduced into the fuel chamber to the fuel-tank side, wherein an opening and closing mechanism provided in the return channel opens at engine startup to allow the fuel to pass through and closes during engine operation to prevent the fuel from passing through.

2. The diaphragm carburetor of claim 1, wherein the opening and closing mechanism includes a valve body that opens in conjunction with a choke operation at engine startup and closes by a choke state being released.

3. The diaphragm carburetor of claim 2, wherein the opening and closing mechanism further comprises:
a choke shaft comprising a notch; and
an insertion hole to receive the choke shaft such that the chock shaft can rotate axially within a predetermined range, and wherein the return channel is disposed on an inner peripheral face of the insertion hole;
wherein during a choke release, the notch is rotated away from the fuel supply channel and the return channel such that the choke shaft is blocking fluid communication between the fuel supply channel and the return channel, and
wherein during a choke position, the notch is rotated to the same side of the fuel supply channel and the return channel such that fluid communication is established between the fuel supply channel and the return channel.

4. The diaphragm carburetor of claim 2, wherein the opening and closing mechanism further comprises:
a hole having a proximal end and a sidewall, wherein the fuel supply channel is disposed on the proximal end of the hole, and the return channel is disposed on the sidewall of the hole; and
a piston member slidably attached to the hole by one or more spring members;
wherein during a choke release, the piston is driven toward the proximal end of the hole such that the piston is blocking fluid communication between the fuel supply channel and the return channel, and
wherein during a choke position, the piston is driven toward a distal end of the hole such that fluid communication is established between the fuel supply channel and the return channel.

5. The diaphragm carburetor of claim 1, wherein the pump means, which actuates by reciprocatingly displacing a diaphragm by introducing pulsation from an engine, is provided on an upstream side of the pressure regulator in the fuel supply channel.

6. The diaphragm carburetor of claim 2, wherein the pump means, which actuates by reciprocatingly displacing a diaphragm by introducing pulsation from an engine, is provided on an upstream side of the pressure regulator in the fuel supply channel.

7. The diaphragm carburetor of claim 3, wherein the pump means, which actuates by reciprocatingly displacing a diaphragm by introducing pulsation from an engine, is provided on an upstream side of the pressure regulator in the fuel supply channel.

8. The diaphragm carburetor of claim 4, wherein the pump means, which actuates by reciprocatingly displacing a diaphragm by introducing pulsation from an engine, is provided on an upstream side of the pressure regulator in the fuel supply channel.
